(19) United States
(12) Patent Application Publication
(10) Pub. No.: US 2005/0055215 A1
(43) Pub. Date: Mar. 10, 2005

(54) System for generating medical records

(76) Inventor: Nancy Klotz, Lawrence, NY (US)

Correspondence Address: Charles E. Temko, 22 Marion Road, Westport, CT, 06880, US

(21) Appl. No.: 10/656,939

(22) Filed: Sep. 8, 2003

(51) Int. Cl. G10L 11/00

(52) U.S. Cl. 704/275

(57) ABSTRACT

A voice-activated system for creating medical records enabling the production of individual patient records from stored data bases responsive to specialized voice recognition commands including stored vocabulary and scripts in combination with digital imaging technologies to produce any of medical reports, consultation letters, nurses notes, and patient instruction sheets.

### BACKGROUND OF THE INVENTION

This invention relates generally to the field of stored data, recall and assembly, and more particularly to an improved voice-actuated system particularly suitable for use by physicians practicing a variety of medical specialties for generation of printed records on an individual patient basis.

Voice recognition systems for performing data assembly are known in the art, and the invention lies in specific constructional details, and a novel method of use. In typical prior art procedure, the physician dictates his report for manual transcription followed by transmission to the physician by e-mail for editing, correction of typographical errors, and the like, for later integration with reproduction of image data such as x-rays, digitized images, and the like. Such procedure is excessively time-consuming, and thus reduces the time available during normal business hours for patients visits, treatment, and consultation. This problem has become particularly apparent in recent years, where the necessity of seeing as many patients as possible during a given time span has become an economic necessity.

### SUMMARY OF THE INVENTION

Briefly stated, the invention contemplates a voice recognition activated computer based system which permits the user to assemble a printed individual patient report by accessing previously stored texts, data imaging, specialized medical vocabulary, using voice recognition technology which enables practically instantaneous editing prior to and during display before the printing of the individual report. Thus, the report can be prepared during a patient examination, and immediately available thereafter, printing as many copies as may be required. Pre-stored medical prescriptions may be made available for the patient at the same time.

### BRIEF DESCRIPTION OF THE DRAWINGS

In the drawing, to which reference will be made in the specification:

FIG. 1 is a view showing a typical patient report prepared in accordance with the present invention.

FIG. 2 is a block diagram showing operation of the disclosed embodiment.

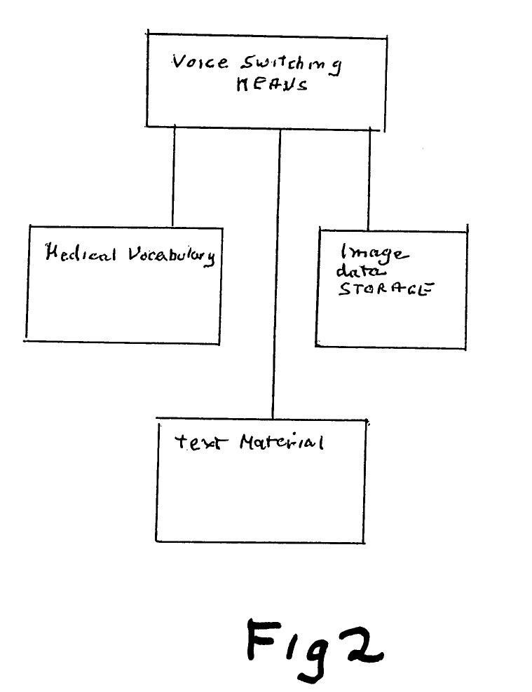

### DETAILED DESCRIPTION OF THE DISCLOSED EMBODIMENT

For purposes of illustration only, the system is described assuming the user to be a gastroenterologist or proctologist. During an office visit, the patient will normally be interviewed for his subjective input, and a visual examination will be followed by a colonoscopy, the result of which is digitally imaged and stored. This may be supplemented, where indicated, by an ultrasonic probe examination for tissue analysis and the like.

Based upon acquired information, the user may prepare a report in as much detail as required.

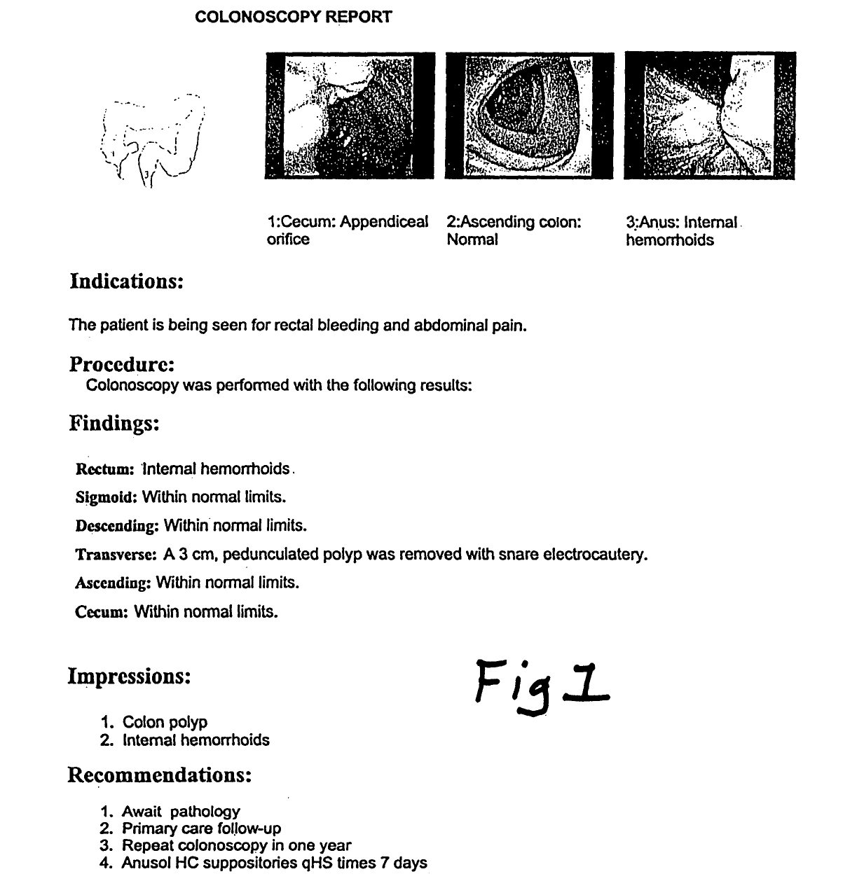

FIG. 1 illustrates a typical single-page report, including an image colonoscopy display, the likely indications, and a discussion of the colonoscopy printout, as well as present and future recommended treatment.

Each of these items is obtained from an individual data storage base. Other storage bases include specialized medical vocabulary also responsive to voice-actuated sensing and switching devices which sense individual syllable combinations to access the desired stored items of data.

The user then makes a sample printing form in which the content is edited, where necessary, using known word processing, and a final copy is prepared and displayed. Any individual additional comment may be vocally inserted at this time. The result is printed in as many copies as desired.

Any other necessary documentation, using the stored or inserted data may also be prepared at this time. This may include letters to a forwarding physician, medical prescriptions, nurses notes, or in some cases, an individual letter to the patient. If appropriate, the entire printed material may be transmitted to another location using known data transmission techniques.

It may thus be seen that I have invented a novel system for generating individual medical records, in which the necessity of employing out-sourced transcribing is substantially eliminated, together with the capability of producing the documentation within a very short period of time, often during a patient visit. With minor modification, the system may be employed by a variety of individual medical specialists. For the preparation of generated reports, all that is necessary on the part of the user are a series of vocal commands which implement corresponding software and storage bases to assemble required documentation. As is the case with most computer programming, proper safeguards may be incorporated into the data bases to assure privacy and access on a need-to-know basis.

I wish it to be understood that I do not consider the invention to the limited to the details of structure set forth in the specification, for obvious modifications will occur to those skilled in the art to which the invention pertains:

1. In a system for generating medical reports and associated documentation using stored data bases and related software programming for assembling information, the improvement comprising: voice-recognition switching means, a stored medical vocabulary, data imaging storage means, and means for storing commonly used text data for selective recall; whereby said switching means, using voice-recognition, selectively assemblies an individual record.

2. The method of preparing an individual patient medical record comprising the steps of:
a) providing a plurality of stored data bases, including a medical vocabulary, image data storage, and commonly used text material;
b) providing a voice recognition switching means controlling said data bases, and;
c) using said switching means to selectively assemble an individual record.

3. The method in accordance with claim 2, including the further steps of:
d) displaying an assembled record, and
e) using voice commands to edit the displayed record prior to printing.
